(19) United States
(12) Patent Application Publication
(10) Pub. No.: US 2007/0278403 A1
(43) Pub. Date: Dec. 6, 2007

(54) Sift-Ms Instruments

(76) Inventors: Murray James McEwan, Christchurch (NZ); Paul Francis Wilson, Christchurch (NZ)

Correspondence Address: D. PETER HOCHBERG CO. L.P.A., 1940 EAST 6TH STREET, CLEVELAND, OH, 44114, US

(21) Appl. No.: 11/667,244

(22) PCT Filed: Nov. 7, 2005
(86) PCT No.: PCT/NZ05/00296

§ 371 Date: May 8, 2007

(30) Foreign Application Priority Data
Nov. 8, 2004 (NZ) 536390

(51) Int. Cl. H01J 49/04

(52) U.S. Cl. 250/292

(57) ABSTRACT

A method of improving the signal intensity of precursor ions in the flow tube of a SIFT-MS instrument by separately and simultaneously injecting a first buffer gas and a second buffer gas into the flow tube through separate concentric apertures in a flange located in a venturi type inlet, the venturi including a central orifice through which precursor ions art also injected into the flow tube.

### BACKGROUND TO THE INVENTION

The selected ion flow tube (SIFT) technique is a modification of the flowing afterglow technique for measuring the kinetic parameters of ion-molecule reactions. The SIFT extension of this technique was developed by Adams and Smith (International Journal of Mass Spectrometry and Ion Physics, 21 (1976) 349) for measuring the kinetic parameters of mass-selected ions and molecules. In this method it is necessary to introduce an ion from a low pressure region (typically 10⁻⁵ Torr) against a pressure gradient into a higher pressure region (typically 0.3 Torr or higher). It is common practice to utilize a venturi-type nozzle to achieve the introduction of ions from the ion selection region into the flow tube where the chemical reactions occur.

A number of different nozzles have been tested. Dupeyrat et al (International Journal of Mass Spectrometry and Ion Physics, 44 (1982) 1) have compared the performance of an annulus design in which the ions are injected through a small hole surrounded by a narrow annulus in which a buffer gas, usually helium, is also added. An alternative design was that of Adams and Smith who introduced the ions through a small hole surrounded by a series of 12 small holes each 1 mm diameter placed on the circumference of a circle of 20 mm diameter. Dupeyrat et al. compared the turbulence of the two nozzles in the flow tube at different flows of helium. They also briefly examined the effect of adding different buffer gases such as argon and nitrogen.

In an attempt to reduce the amount of turbulence, Mackay et al (International Journal of Mass Spectrometry and Ion Physics, 36 (1980) 259) introduced a second annulus having a larger diameter than the inner annulus. Part of the helium buffer gas was diverted through this outer annulus. Fishman and Grabowski (International Journal of Mass Spectrometry 177 (1998) 175) also examined the effect of having dual injectors on a venturi nozzle where each injector contained a series of holes on two different circle diameters. Milligan et al (International Journal of Mass Spectrometry, 202 (2000) 351) compared the performances of dual hole injectors with dual annuli injectors.

Selected ion flow tube mass spectrometry (SIFT-MS) is a development of SIFT technology (Smith and Spanel, Medical and Biological Engineering and Computing, 34 (1996) 409) and is a technique that utilizes a similar venturi orifice to that used in SIFT technology. SIFT-MS is a technique that is used to monitor the amounts of volatile components in air in real time. The basis of the technique is that precursor ions (commonly H₃O⁺, O₂⁺ and NO⁺) are generated in a vacuum chamber at the upstream end of a flow tube. The ions are then mass selected using a mass filter and injected into the flow tube against a pressure gradient by use of a venturi nozzle.

The mass selected precursor ions are then entrained in a buffer gas and flow down the flow tube. Helium is usually chosen as the buffer gas because it has a low molar mass and thus the energy transfer in collisions between ions and the buffer gas in the injection process is minimised. Reducing the energy of the collisions reduces the extent of fragmentation of the precursor ions during injection.

A known flow of sample may be introduced to the flow tube by means of a heated capillary tube and chemical reactions will take place between the analyte species and the precursor ions. The extent of the reaction is monitored by measuring the reduction of intensity of the precursor ion signal, and the magnitude of product ion signals at the end of the flow tube. From the comparison of primary (precursor) and product ion signals, the identity and concentration of volatile species in the sample may be calculated if the reaction rate and flow dynamics of the system are known.

The sensitivity of the SIFT-MS technique depends on the number of precursor ions that reach the downstream end of the flow tube. The greater the intensity of the precursor ion signal; measured in counts per second (cps), the greater the sensitivity of the technique. At low concentration of analyte most of the ion loss within the flow tube occurs as a result of diffusion of the ions in the buffer gas.

Diffusive loss of ions can be greatly reduced by using an inert buffer gas of greater molar mass than helium but using this gas as the sole buffer gas causes fragmentation of the precursor ion during the injection process. The diffusive loss can also be reduced by increasing the flow of buffer gas, or reducing the time for ions to reach the end of the flow tube, but this has a downside in that it increases the pumping load and uses more gas.

### OBJECT OF THE INVENTION

An object of the invention is to improve the signal intensity of the precursor ions at the downstream end of the flow tube of a SIFT-MS instrument without a substantial increase in tube pressure or in the amount of buffer gas required.

It is a further object of this invention to provide a venturi type inlet to the flow tube of a SIFT-MS instrument that will allow the simultaneous but separate injection of two buffer gases and precursor ions into the flow tube of a SIFT-MS instrument.

### DISCLOSURE OF THE INVENTION

In one form the invention is a method of improving the signal intensity of the precursor ions in the flow tube of a SIFT-MS instrument when using a venturi inlet, the method comprising forming a first and a second concentric aperture in the venturi and injecting a flow of a first buffer gas through the first concentric aperture into the flow tube and injecting a second buffer gas through the second concentric aperture into the flow tube, the venturi also including a central orifice through which precursor ions may be injected into the flow tube.

Preferably the first buffer gas is injected into the flow tube through the inner concentric aperture and the second buffer gas is injected into the flow tube through the outer concentric aperture.

Preferably the first and second concentric apertures comprise an inner annulus through which the first buffer gas is injected into the flow tube and an outer annulus through which the second buffer gas is injected into the flow tube.

Preferably the first and second concentric apertures comprise an inner ring of orifices through which the first buffer gas is injected into the flow tube and an outer ring of orifices through which the second buffer gas is injected into the flow tube.

Preferably the first and second concentric apertures comprise a combination of an annulus and a ring of orifices.

Preferably the first buffer gas is helium.

Preferably the second buffer gas is nitrogen

Preferably the second buffer gas is argon or other non-reactive gas.

Preferably the second buffer gas has a heavier molecular weight than the first buffer gas.

Preferably the inner concentric aperture is closely proximate to the central orifice.

Preferably the first and second concentric apertures and the central orifice are located in a flange placed at an entrance to the flow tube.

In another aspect the invention includes a venturi type inlet through which a first buffer gas, a second buffer gas and precursor ions can be separately injected into the flow tube of a SIFT-MS instrument, said inlet including

a first aperture through which the first buffer gas can be injected into the flow tube,

a second aperture through which the second buffer gas can be injected into the flow tube,

the said first and second apertures being concentric with a central orifice through which the precursor ions can be injected into the flow tube.

Preferably the first buffer gas is injected into the flow tube through the first aperture and the second buffer gas is injected into the flow tube through the second aperture.

Preferably the first aperture is the inner aperture and the second aperture is the outer aperture.

Preferably the first aperture is an inner annulus and is formed to allow the passage of the first buffer gas into the flow tube,

the second aperture is an outer annulus concentric with the first aperture and is formed to allow the passage of the second buffer gas into the flow tube.

Preferably the venturi inlet includes a flange adapted to be located in an entrance to the flow tube and the first and second concentric apertures each comprise a series of spaced apart orifices formed in the flange.

Preferably the venturi inlet includes a flange adapted to be located in an entrance to the flow tube and the first and second concentric apertures each comprise an annulus formed in the flange.

Preferably the venturi inlet includes a flange adapted to be located in an entrance to the flow tube and the first and second concentric apertures comprise a combination of an annulus and orifices formed in the flange.

### BRIEF DESCRIPTION OF THE DRAWINGS

FIG. 1 is a diagrammatic face view of one form of a venturi nozzle according to the present invention.

FIG. 2 is a sectional side view of the nozzle illustrated in FIG. 1.

FIG. 3 is a diagrammatic face view of another form of a venturi nozzle according to the present invention.

FIG. 4 is a sectional exploded side view of the nozzle illustrated in FIG. 3.

### BEST MODE OF PERFORMING THE INVENTION

The invention is performed using a venturi injector possessing two or more concentric apertures around a central orifice through which the precursor ions are injected. The apertures which have separate gas supplies may be of the annular type or may consist of concentric rings of holes or it may consist as a combination of the two.

The method of the present invention consists in introducing two distinct buffer gases into the flow tube. The first buffer gas which is introduced through the inner concentric aperture will generally be helium, but may be another, appropriate, gas such as hydrogen. The second buffer gas is a non reactive buffer gas selected from the range of suitable buffer gases and will be of a heavier molecular weight than the first buffer gas. The second buffer gas is introduced into the flow tube through the outer of the concentric apertures.

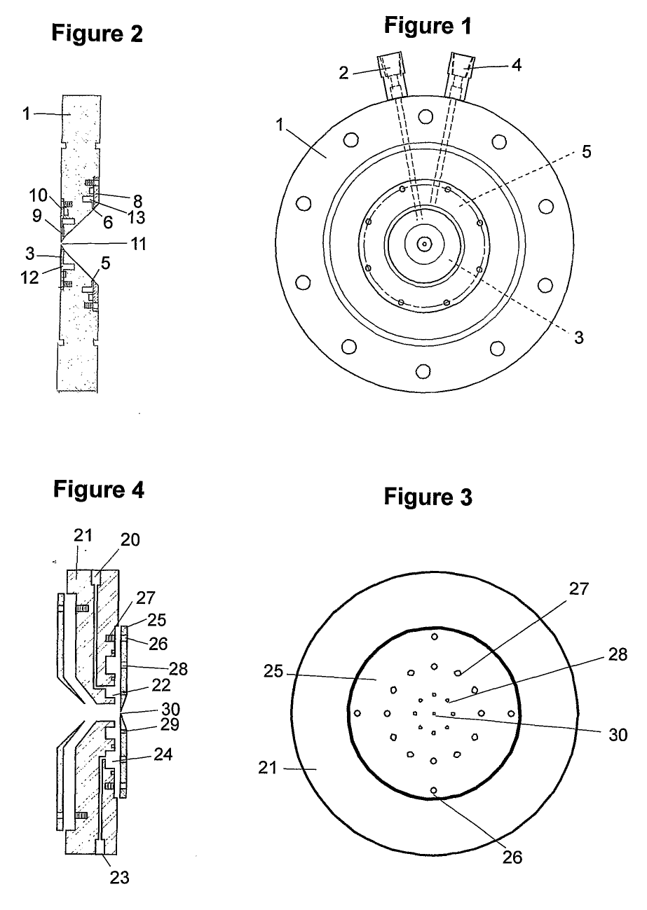

One form of an annular type venturi according to this invention is illustrated in FIGS. 1 and 2. The venturi is constructed with a main flange 1 which is located in an entrance to the flow tube (not shown in the drawings). The main flange 1 includes an aperture 2 for the first buffer gas in the inner annulus 3 of the flange 1 and an aperture 4 for the second buffer gas in the outer annulus 5. As illustrated, the outer annulus 5 is formed by a gap 6 between the main flange 1 and a secondary flange 8 and the inner annulus 3 is formed by a gap 9 between the flange 1 and a tertiary flange 10. The flange 1 also includes an ion injection orifice 11. Preferably the inner annulus 3 is located as close as possible to the ion injection orifice 11 through which the precursor ions are injected.

In a highly preferred form as illustrated in FIGS. 1 and 2, the aperture 2 for the first buffer gas terminates in a circular groove 12 formed between the tertiary flange 10 and the flange 1. The aperture 4 for the second buffer gas terminates in a circular groove 13 formed in the secondary flange 8 and the flange 1.

FIGS. 3 and 4 illustrate a venturi injector flange which utilises concentric rings of holes in place of the annuli illustrated in FIG. 1 and 2. An aperture 20 for the first buffer gas is formed in the flange 21 and terminates in a circular groove 22 formed in the flange. An aperture 23 for the second buffer gas is also formed in the flange 21 and terminates in a circular groove 24 formed in the flange. The first buffer gas will generally be helium but any other suitable buffer gas can be utilised, provided it is a different gas from the second buffer gas. The second buffer gas is preferably nitrogen or argon or any other non-reactive gas of a heavier molar weight than the first buffer gas.

A face plate 25 is attached to the face of the flange 21 for instance by machine screws which pass through appropriate holes 26 formed in the face plate and which are screwed into threaded holes 27 formed in the flange 21. The face plate 25 includes two series of orifices 28 and 29 formed preferably as two concentric rings with the outer ring of orifices 29 communicating with the groove 24 and the inner ring of orifices 28 communicating with the circular groove 22. The face plate 25 also includes a central orifice 30 through which ions are injected.

The gas supply to the apertures 2, 4, (see FIG. 1) and 20 and 23 (see FIG. 4) is preferably controlled by mass flow controllers.

Increase in Precursor Intensity Due to Heavier Buffer Gas.

The effect of using a second heavier buffer gas which is a different gas from the first buffer gas added through the inner venturi orifice is demonstrated in graph A below. With 8000 standard cubic centimetres per minute of the first buffer gas which for this experiment is helium passing through the inner annulus, the effect of adding further helium, nitrogen or argon through the outer annulus is shown as a function of the flow through the outer annulus. The significant increase in ion signal where nitrogen or argon is added as the second buffer gas is due to reduced diffusion loss of the precursor ions in the flow tube. This graph depicts the increase in H₃O⁺ signal intensity which was achieved by adding nitrogen, argon and helium through the outer annulus of a SIFT-MS instrument (with 8000 sccm of helium through the inner annulus).

[image]

Rates of Bimolecular Reactions Not Altered by Change in Buffer Gas.

The technique of SIFT-MS relies in part upon the rate of reaction between the precursor ion and the analyte being known. The most important and numerous class of reactions are bimolecular reactions between the precursor ion and the analyte neutral. This class included charge and proton transfer reactions. It is important to show that changing the nature of the buffer gas does not alter the rate of bimolecular processes.

Graph B below shows the measured rates for the bimolecular reactions of O₂⁺ with (a) ethane and (b) acetylene. The rates were measured at different flows of buffer gas, with the composition of buffer gas varying from 100% helium to around 10% helium with nitrogen added. Helium was added from the inner annulus and nitrogen from the outer. The figure shows that at pressures above 0.1 Torr in the flow tube true bimolecular behaviour is observed. At pressures of 0.1 Torr and below there is a change in the flow conditions such that the flow velocity ratio of Vᵢₒₙₛ/Vₙₑᵤₜᵣₐₗₛ is changing due to turbulence effects.

[image]

The graph C below shows the same measurements as graph B plotted as a function of buffer gas composition. The two points at a composition of 50% helium: 50% nitrogen represent the measurements at a pressure of around 0.1 Torr, and display the variation in rate coefficient at low pressures as noted in Graph B described above. The other points demonstrate that there is no dependence of the bimolecular rate on the composition of the buffer gas given that the tube pressure is higher than 0.1 Torr.

[image]

It is therefore apparent from the employment of the change in operation of the venturi type aperture that it is possible to reduce the ion loss due to diffusion in helium by changing the main buffer gas from helium to argon, or nitrogen, or some other non-reactive buffer gas of higher molar mass added through the outer venturi injector or separate aperture, while still utilising a small flow of helium through the inner venturi injector to minimise collisional fragmentation of the precursor ions.

Having described preferred methods of putting the invention into effect, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. A method of improving the signal intensity of the precursor ions in the flow tube of a SIFT-MS instrument when using a venturi inlet, the method comprising forming a first and a second concentric aperture in the venturi and injecting a flow of a first buffer gas through the first concentric aperture into the flow tube and injecting a second buffer gas through the second concentric aperture into the flow tube, the venturi also including a central orifice through which precursor ions may be injected into the flow tube.

2. (canceled)

3. The method of claim 1 wherein the first and second concentric apertures respectively comprise an inner annulus through which the first buffer gas is injected into the flow tube and an outer annulus through which the second buffer gas is injected into the flow tube.

4. The method of claim 1 wherein the first and second concentric apertures respectively comprise an inner ring of orifices through which the first buffer gas is injected into the flow tube and an outer ring of orifices through which the second buffer gas is injected into the flow tube.

5. The method of claim 1 wherein the first and second concentric apertures comprise a combination of an annulus and a ring of orifices.

6. The method of claim 1 wherein the first buffer gas is helium.

7. The method of claim 1 wherein the second buffer gas is nitrogen

8. The method of claim 1 wherein the second buffer gas is argon or other non-reactive gas.

9. The method of claim 1 wherein the second buffer gas has a heavier molecular weight than the first buffer gas.

10. The method of claim 1 wherein the inner concentric aperture is closely proximate to the central orifice.

11. The method of claim 1 wherein the first and second concentric apertures and the central orifice are located in a flange placed at an entrance to the flow tube.

12. A venturi type inlet through which a first buffer gas, a second buffer gas and precursor ions can be separately injected into the flow tube of a SIFT-MS instrument, said inlet including:
a first aperture through which the first buffer gas can be injected into the flow tube,
a second aperture through which the second buffer gas can be injected into the flow tube,
said first and second apertures being concentric with a central orifice through which the precursor ions can be injected into the flow tube.

13. The venturi type inlet of claim 12 wherein first buffer gas is injected into the flow tube through the first aperture and the second buffer gas is injected into the flow tube through the second aperture.

14. The venturi type inlet of claim 13 wherein the first aperture is the inner aperture and the second aperture is the outer aperture.

15. The venturi type inlet of claim 12 wherein
the first aperture is an inner annulus and is formed to allow the passage of the first buffer gas into the flow tube,
the second aperture is an outer annulus concentric with the first aperture and is formed to allow the passage of the second buffer gas into the flow tube.

16. The venturi type inlet of claim 12 wherein the venturi inlet includes a flange adapted to be located in an entrance to the flow tube and the first and second concentric apertures each comprise a series of spaced apart orifices formed in the flange.

17. The venturi type inlet of claim 12 wherein the venturi inlet includes a flange adapted to be located in an entrance to the flow tube and the first and second concentric apertures each comprise an annulus formed in the flange.

18. The venturi type inlet of claim 12 wherein the venturi inlet includes a flange adapted to be located in an entrance to the flow tube and the first and second concentric apertures comprise a combination of an annulus and orifices formed in the flange.
